(19) United States
(12) Patent Application Publication
(10) Pub. No.: US 2011/0167596 A1
(43) Pub. Date: Jul. 14, 2011

(54) Magnetic jewelry converter adapter link

(76) Inventor: Lisa O. Whyte, Prospect, KY (US)

(21) Appl. No.: 12/930,085

(22) Filed: Dec. 27, 2010

Related U.S. Application Data
(60) Provisional application No. 61/284,923, filed on Dec. 28, 2009.
(60) Provisional application No. 61/284,934, filed on Dec. 26, 2009.

(51) Int. Cl. H01F 7/02

(52) U.S. Cl. 24/303

(57) ABSTRACT

A magnetic adapter link includes a magnetic converter having a center base including at least one magnet or magnetic material, or magnetizable material forming a magnetic center core defining a magnetic mounting disc. A pair of magnetic end posts form clasp portions each one extending from a side edge of the magnetic converter at a selected angle from one another and each end posts having a detachable distal end containing a magnet or magnetic material or magnetizable material. The detachable distal ends of the magnetic end posts are spaced apart from the center base and from one another at one or more selected positions for detachably connecting to the first clasp portion and/or the second clasp portion of a necklace or bracelet which include at least one pair of detachable distal ends containing a magnet or magnetic material or magnetizable material. An ornament such as a jewel having a magnet, magnetic material or magnetic metal affixed to its rear surface can be removably attached to the magnetic converter.

### RELATED APPLICATIONS

This application claims priority from Provisional application Ser. No. 61/284,923 filed on Dec. 26, 2009 which is hereby incorporated by reference.

### FIELD OF INVENTION

This invention relates in general to hardware for a decorative-magnetic jewelry adapter link having a converter with a magnetic base center and magnetic end posts arranged on the side edges at selected positions circumferentially around the magnetic base center in order for detachably connecting the distal ends of a necklace or bracelet having magnetic of magnetizable distal end portions and providing a means for securing a broach or other jewelry thereto having a magnet or magnetizable material backing.

### BACKGROUND OF INVENTION

Conventional jewelry pieces utilize a single method of attachment such as a pin, clip, or clasp to hold a jewelry piece onto the a garment, or in the case of necklaces or bracelets a clasp such as a hook and loop arrangement are used to connect the distal ends of the jewelry. There was really not a good method available to utilize a decorative jewelry piece together with a necklace.

Means were needed to provide an interface between a decorative jewelry piece such as a broach with a necklace or the like.

### SUMMARY OF INVENTION

In keeping with the foregoing objective, there is provided in accordance with one aspect of the present invention a magnetic adapter link includes a magnetic converter having a center base including at least one magnet or magnetic material, or magnetizable material forming a magnetic center core defining a magnetic mounting disc. A pair of magnetic end posts form clasp portions each one extending from a side edge of the magnetic converter at a selected angle from one another and each end posts having a detachable distal end containing a magnet or magnetic material or magnetizable material. The detachable distal ends of the magnetic end posts are spaced apart from the center base and from one another at one or more selected positions for detachably connecting or linking to the first clasp portion and/or the second clasp portion of a necklace or bracelet which include at least one pair of detachable distal ends containing a magnet or magnetic material or magnetizable material. An ornament such as a jewel having a magnet, magnetic material or magnetic metal affixed to its rear surface can be removably attached to the magnetic converter.

It is an object of the present invention is to provide a decorative magnetic converter that has means associated therewith for anchoring each end to a necklace and provide a center base for magnetically securing a detachable jewelry piece such as a broach.

It is another object of the present invention to provide a jewelry adapter link to allow an individual to utilize a stand alone jewelry piece in combination with a necklace.

It is another object of the present invention to provide an converter base consisting of a frame having a front portion connecting to a rear portion connecting together to removably hold a magnet, magnetic material, or magnetizable material contained there between.

It is another object of the present invention to provide a converter comprising a locket having a concave top portion and a concave bottom portion hingedly connected together and including a clasp means for holding said top and bottom together including a magnet, magnetic material, or magnetizable material contained there between.

It is another object of the present invention to provide a converter comprising a locket having a top portion and a concave bottom portion hingedly connected together and including a clasp means for holding said top and bottom together including a magnet, magnetic material, or magnetizable material contained there between.

It is another object of the present invention to provide a converter comprising a locket having a concave top portion and a concave bottom portion connected together by hooks and loops means extending around the periphery thereof including a magnet, magnetic material, or magnetizable material contained there between.

It is another object of the present invention to provide a converter comprising a locket having a top portion and a concave bottom portion connected together by a plurality of hook and loop means extending around the periphery thereof including a magnet, magnetic material, or magnetizable material contained there between.

In accordance with a further aspect of the present invention there is provided an assemblage of components for decoratively retaining a necklace to a magnetic converter having a decorative outer face and an oppositely disposed inner face and a magnet or magnetic material or magnetizable material disposed therein with at least two connecting posts projecting from the outer periphery thereof at selected opposing angles from one another for detachable connecting to the distal end links or clasps of necklaces.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a prospective view of a magnetic converter adapter link of the present invention;

FIG. 2 is a perspective view of a necklace including magnetic posts clasps at the distal ends;

FIG. 3 is a perspective view of a piece of ornamental jewelry including a magnet affixed to its rear surface for detachable connection to the magnetic converter;

FIG. 4 is a perspective view showing a necklace having magnetic distal end posts connecting to end posts extending from a magnetic converter adapter;

FIG. 5 is a perspective view of an alternate piece of ornamental jewelry including a magnet affixed to its rear surface for detachable connection to the magnetic converter; and

FIG. 6 is a perspective rear view of the converter adapter including an ornamental jewelry piece attached to its front surface and the magnetic post distal ends of the necklace connecting to the distal ends of the magnetic posts of the converter adapter.

### DETAILED DESCRIPTION OF PREFERRED EMBODIMENT

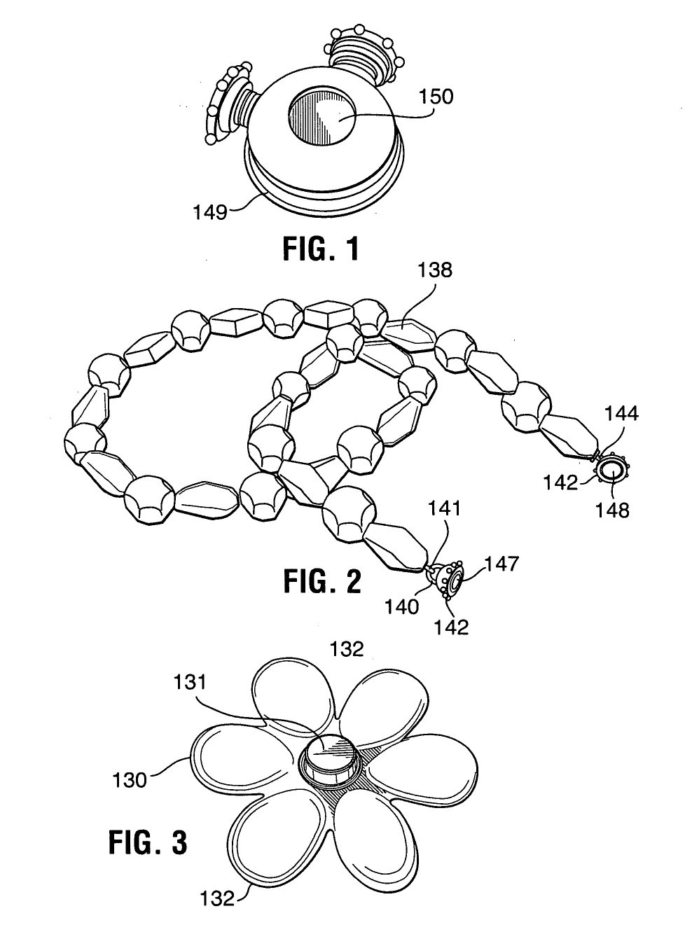

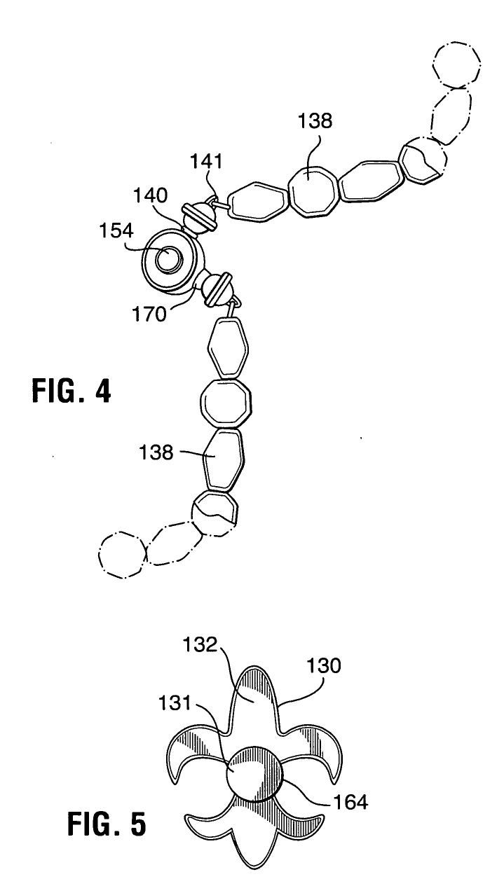

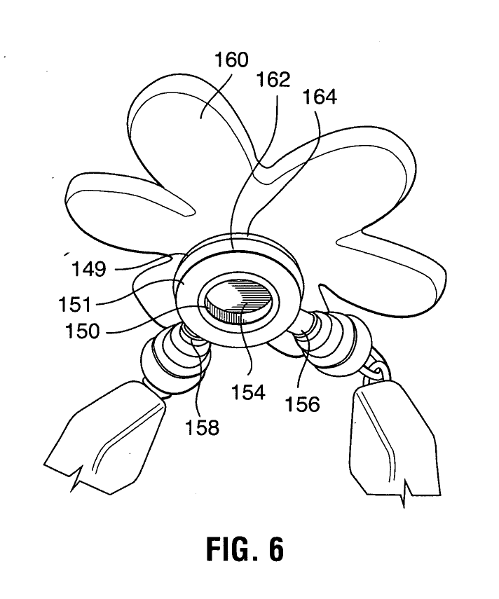

FIGS. 1-6 are oblique views of applicants magnetic adapter link 149, ornamental jewelry piece 130, and magnetic clasp posts 142.

The magnetic converter 149 has a center base including at least one magnet or magnetic material, or magnetizable material forming a magnetic center core defining a magnetic mounting disc. A pair of magnetic end posts 142 form clasp portions each one extending from a side edge of the magnetic converter 149 at a selected angle from one another and each end posts 142 having a distal end containing a magnet or magnetic material or magnetizable material. The distal ends of the magnetic end posts are spaced apart from the center base and from one another at one or more selected positions for detachably connecting to the first clasp portion and/or the second clasp portion of a necklace or bracelet which include at least one pair of magnetic detachable distal end posts 142 containing a magnet or magnetic material or magnetizable material. The ornament jewelry piece 130 having a magnet, magnetic material or magnetic metal affixed to its rear surface can be removably attached to the magnetic converter.

More particularly, the clasp portions are detachably interconnecting and preferably comprise permanent magnets with one clasp portion being of a polarity opposite to that of the other. This permits a simple and easy detachable interconnection of the opposite ends to provide a closed loop clip. Preferred magnets are rare earth magnets. The most common types of rare earth magnets are samarium-cobalt and neodymium-iron-boron (NIB) magnets. Neodymium-iron-boron (NIB) magnets are among the strongest. These cost more per kilogram than most other magnetic materials, but owing to their intense field, are smaller and cheaper in many applications. The instant invention utilizes samarium-cobalt, neodymium-iron-boron magnets, and combinations thereof.

An ornamental piece 130 can be formed by attaching a magnet 131 to a rear surface of a jewelry piece 132 such as a flower by welding, brazing, soldering, adhesives. As shown in FIG. 3, the ornamental piece 130 can utilized as an independent jewelry piece to be fastened to the front face of the converter 149 or removably secured thereto by a magnet. The ornamental piece 130 can also be used as a broach, by sliding another magnet underneath a piece of clothing and attaching a magnet 131 or other magnetizable material, for example, steel, thereto in order to removably hold the broach in position. The ornamental piece can be sold as a kit with interchangeable magnetic mix and match pieces.

As further shown in FIGS. 1-6, a necklace 138 is shown wherein a first distal end post 140 defining a first clasp is connected at one end thereof to a loop 141 extending from the distal end of the necklace, wherein the loop 141 is fixedly mounted to a recessed housing 142 containing a magnet 147 or magnetic material affixed thereto or disposed therein forming a first clasp portion 140. At the opposite end of the necklace a second distal end post or second clasp 144 is optionally connected to the first clasp portion 140. These distal end posts are detachably interconnecting and preferably comprise permanent magnets 147, 148, respectively, with one end post being of a polarity opposite to that of the other. This permits a simple and easy detachable interconnection of the opposite ends to provide a detachable closed loop connection.

The necklace illustrated in FIGS. 1-6, show a centerpiece comprising a magnetic converter adapter 149 including a magnet holding member comprising a recessed or hollow base 150 forming a depression or socket for holding a magnet 147, 148 disposed therein, said converter adapter having a front surface 151 and a rear surface (not shown). At least one of said front surface 151 and/or said rear surface being magnetic and in magnetic communication with a permanent magnet or magnetic material 154 affixed thereto or held disposed therein, preferably forming a generally flat mounting disc. An ornament such as a jewel 130 having a magnet, magnetic material or magnetic metal 131 affixed to its rear surface 164 can be removably attached to the base 150 of the converter 149.

One preferred embodiment of the converter 149 is formed of a two piece ornamental locket wherein a magnet is inserted there between. Although the embodiment shown exposes both sides of the magnet 154 held therein, it is contemplated that the converter 149 could include a nonmagnetic backing material. Moreover, the converter could be formed from a polymer wherein a magnet could be removably slipped between front and rear holding members such as a flexible disc of plastic material having a hollow interior, secured by side holding means such as prongs or the like, and/or formed having a magnetic front face, magnetic rear face, or magnetic front and rear face. The magnet 154 shown in the converter adapter 149 is removable, but could be permanently disposed therein. Moreover, the converter could be formed as a locket utilizing a front panel hingedly connecting to a rear panel rather than attached as shown by interconnecting prongs 170.

A pair of detachably interconnecting clasp portions define magnetic posts 156, 158 having a magnet or magnetic material 147, 148 are spaced apart from one another along the side edge or periphery of the converter adapter 149 at selected positions for detachably connecting to the first clasp portion 142 and the second clasp portion 146 of a necklace 138. A first converter post 156 and second converter post 158 are affixed to the side edge of the converter by soldering, welding, adhesive, glue, or integrally formed to the converter body 146 to connect to a selected distal end 140, 142 of the necklace 138, wherein the converter posts 156, 158 each include a recessed housing 142 containing a magnet 147, 148 or magnetic material affixed thereto or disposed therein.

The detachable posts 140, 142 of the necklace 138 can be detachably connected to the opposite charged poles of the converter posts 156, 158 to provide a necklace 138 utilizing the converter as means to support any number of ornamental jewelry pieces there between. This permits a simple and easy detachable interconnection of the opposite ends to provide a detachable closed loop connection.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above.

I claim:

1. A magnetic jewelry converter adapter link comprising:
a magnetic converter having a center base including at least one magnet or magnetic material, or magnetizable material forming a magnetic center core defining a magnetic mounting disc;
at least one pair of magnetic converter end posts extending from a side edge of the magnetic converter at a selected angle from one another and each end posts having a distal end containing a magnet or magnetic material or magnetizable material or a selected polarity;
a first magnetic end post and a second magnetic end post extending from an opposite distal end of a necklace, each one of said end posts having a distal end containing a magnet or magnetic material or magnetizable material or an opposite polarity; and
said first magnetic end post and said second magnetic end posts being magnetically connectable to one another and to one or the other of said at least one pair of magnetic converter end posts.

2. The magnetic jewelry converter adapter link of claim 1, including a jewelry piece including a magnet, magnetic material, or magnetizable material mounted to a surface thereof forming a magnetic base for detachably connecting to said magnetic center core of said magnetic mounting disc.;

3. The magnetic jewelry converter adapter link of claim 1, wherein said magnet, magnetic material is a rare earth magnets.

4. The magnetic jewelry converter adapter link of claim 3, wherein said rare earth magnets are selected from the group consisting of a samarium-cobalt, a neodymium-iron-boron magnet, and combinations thereof.
